(19) United States
(12) Patent Application Publication
(10) Pub. No.: US 2002/0142801 A1
(43) Pub. Date: Oct. 3, 2002

(54) Booster auto detect

(76) Inventors: Bruce Miller, Coquitlam (CA); Ronald J. Vanderhelm, Surrey (CA); Dominique Kwong, Vancouver (CA)

Correspondence Address: Robert Krebs, Thelen Reid & Priest LLP, P.O. Box 640640, San Jose, CA, 95164-0640, US

(21) Appl. No.: 09/823,905

(22) Filed: Mar. 30, 2001

(51) Int. Cl. H04M 1/00

(52) U.S. Cl. 455/557; 455/571

(57) ABSTRACT

A radio modem is connectable to a booster unit to boost the power of the transmitted RF signal. In order to detect the presence or absence of the booster unit, a DC offset is placed on the connector line between the radio modem and the booster unit. The value of the DC offset depends upon whether the booster unit is connected and this DC value can be detected at the radio modem. Baseband signals are sent on the connector line between the radio modem and the booster unit. The baseband signals can include a power control message which allows the booster unit to determine the power level to transmit. Additionally, a switch placed in the transmit line of the booster unit to prevent the input to a power amplifier in the booster to be destructively high if the radio modem unit does not correctly detect the connection to the booster unit.

### BACKGROUND OF THE INVENTION

The present invention relates to radio modem systems especially radio modem systems using booster modules.

Radio modems are becoming quite popular for use with personal computers and personal digital systems. One example of a system that uses such radio modems is the cellular digital packet data (CDPD) Network. Most CDPD systems currently use a 0.6 Watt radio modem operating as a Class 3 device. In some circumstances, it is desirable to increase the power of the system to operate as a Class 1 device at 3 Watts. One way of doing this is to use a booster module boosting the power of the transmitted and received signals. The booster module sits between the radio modem and the antenna. In order to operate on the network correctly, the modem controller must know whether it's a Class 3 device or a Class 1 device. Thus, the radio modem must know whether the booster module is present or not. One way of doing this is to rely on the user to set the configuration that indicates to the modem controller whether a booster is connected or not. The disadvantage of this system is that it can result in a possible error in configuration if the user forgets to select the booster or selects it by mistake. It is desired to have an improved method of detecting the presence or absence of a booster module.

### SUMMARY OF THE INVENTION

One way of detecting the booster module is to use a separate connector line for detecting the presence or absence of the booster module. This results in the user having to plug in two cables, the radio frequency (RF) line connector and the new digital connector line.

In the present invention, direct current (DC) level is added to the RF line connector and is used to indicate whether the booster module is present or not. The connector line between the radio modem unit and the booster unit is mainly used to carry the radio frequency (RF) signal. The use of the DC offset allows an indication to be used on the same line as the transmission of the RF signals without interfering with the RF signals. In one embodiment, inductors are used to isolate the DC offset circuit elements from the RF signal. In one described embodiment, when the radio unit is not connected to a booster module, the radio unit puts a predetermined voltage offset onto the connector. When the booster module is connected to the radio modem, the DC offset is modified. The DC offset at the connectors is detected by the detector in the radio modem unit.

Another embodiment of the present invention sends baseband power control signals from the radio modem unit to the booster unit. These baseband power control signals are preferably sent over the RF connector line. These power control signals allow the booster unit to correctly boost the RF signal from the radio modem unit.

If the radio modem unit doesn't correctly recognize the connection to the booster unit and outputs an excessive power level, the input to the power amplifier of the booster unit can be so high as to cause damage and force it to operate beyond its limit. In another embodiment of the present invention, a switch is used to attenuate undesirable RF energy sent from the radio modem to a power amplifier in the booster unit, until a valid power control message is received from the radio modem. In a preferred embodiment, this switch is provided by using two back-to-back reverse PIN diodes placed in series in the transmit path.

### BRIEF DESCRIPTION OF THE DRAWING FIGURES

FIG. 1 is a diagram that illustrates a radio modem system with a DC offset detector system of the present invention.

FIG. 2 is a diagram that illustrates a radio modem and the booster unit, both having the DC power detector system of the present invention.

FIG. 3 is a diagram that illustrates the use of a switch in the transmit path of the booster circuit in order to avoid damage to the power amplifier of the booster circuit.

FIG. 4 is a diagram of the preferred embodiment of a switch used in the system of the present invention.

FIG. 5 is a diagram of a system of the present invention showing the radio modem attached to the booster unit illustrating the baseband transmission of signals between the modem and booster.

FIG. 6A and 6B illustrate the power control messages transmitted between the radio modem and the booster unit.

FIG. 7 is a flowchart that illustrates the operation of the system of one embodiment of the present invention.

FIG. 8 is a diagram of another embodiment of the present invention.

### DETAILED DESCRIPTION OF THE INVENTION

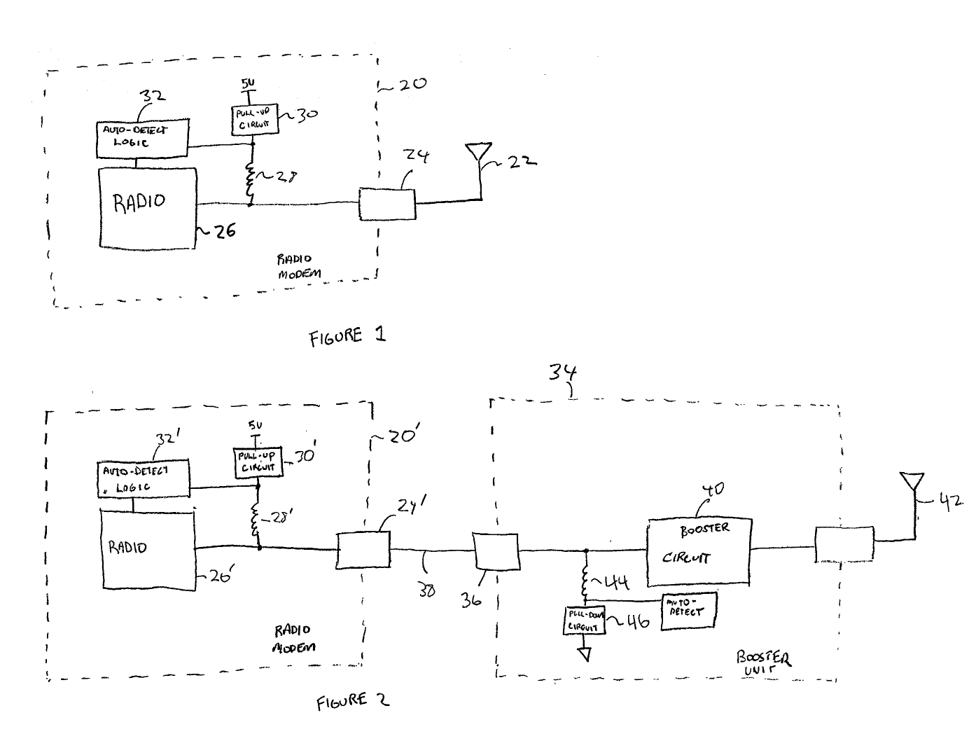

FIG. 1 illustrates a radio modem unit 20 directly connected to an antenna 22 using connector 24. The radio 26 within the radio modem 20 sends radio frequency signals through the connector 24 out to the antenna 22 to be transmitted. The circuit includes an inductor 28, pull-up circuit 30 and auto-detect logic 32. The inductor 28 prevents the radio frequency signal from traveling up into the auto-detect unit but allows a DC offset to travel through the inductor 28 onto the connector 24. In one embodiment, the pull-up circuit puts a five-volt DC offset at the connector 24 which is not affected by attaching an antenna. This five-volt DC offset is detected by the pull-up circuit 32. The auto-detect circuit 32 thus allows the radio to transmit at the power levels appropriate for stand-alone transmission. In one embodiment, the stand-alone transmission is transmission as a CDPD Class 3 device limited to 0.6 Watts. In an embodiment not shown, the pull-up circuit includes a switch to turn off the five-volt DC offset at the connector 24.

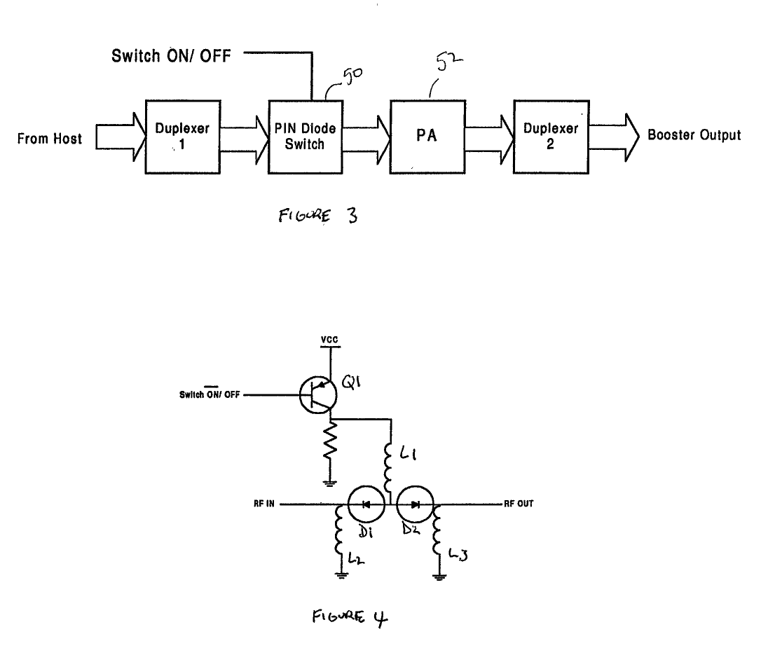

FIG. 2 illustrates the radio modem system of FIG. 1 attached to a booster unit 34. The booster unit 34 is connected using connector 36 to the radio modem 20′. In a preferred embodiment, a connection line 38, such as a coaxial cable, is used to connect between the radio modem and the booster unit. This connection line is used to transmit the radio frequency signals to the booster unit. The booster unit includes circuitry 40 to boost the radio frequency signals to higher power and then transmit using antenna 42. In the preferred embodiment, the booster unit includes an auto-detect circuit including an inductor 44 and pull-down circuit 46. When the booster unit 34 is connected to the radio modem unit 20′, the DC power will be pulled down to a logic low value. In one embodiment, the DC offset at the connectors 24′ and 36 as well as at the auto-detect logic 32′ gets pulled down to 0.5V. The auto-detect logic 32′ then can detect that the booster unit 34 is present and the radio modem can configure itself for the operation in conjunction with the booster unit 34.

FIGS. 3-7 illustrate a system in which baseband power controls signals transmitted between the radio modem and the booster unit connector correctly configure the booster unit for operation. In one embodiment, if the host modem unit logic fails to detect the booster unit when a connection has been made, the modem will operate in normal mode capable of outputting a maximum radio power level of +28 dBm. Given the losses of the transmit path of the booster, the worst case input to the power amplifier would be around +25 dBm RF. This level will surely cause damage to the power amplifier and cause it to operate beyond its limits.

FIG. 3 illustrates a circuitry within the booster unit in which a switch is used in the transmit path to prevent the power amplifier from being overloaded by the radio frequency signals from the radio modem. Looking at FIG. 3, the switch 50 is placed in the transmit path and will normally significantly attenuate the signals in the transmit path. In one embodiment, the attenuation is around 25 dB. Thus, the power amplifier 52 in the booster unit will not be overloaded.

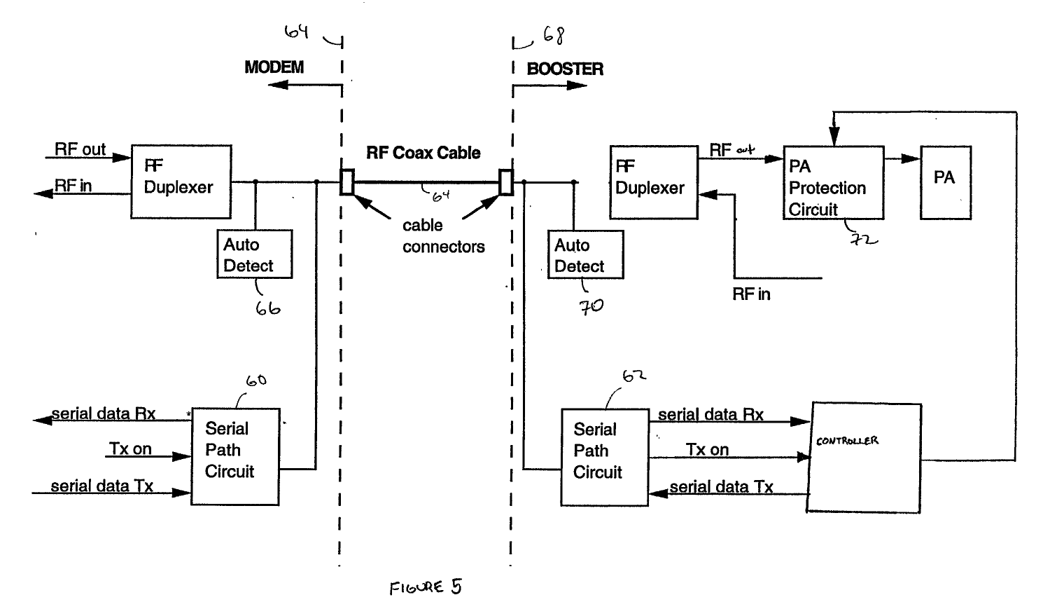

FIG. 4 shows an example of a switch that can be put in the transmit path of the booster unit before the power amplifier. In this embodiment, switch Q1 is turned on by pulling the base low, causing the current to flow through the inductor L1 and split between the two paths D1 and D2, causing them to conduct. This reduces the radio frequency impedance to almost zero, and essentially allows radio frequency signals to flow from the radio frequency input to the radio frequency output. If the controller decides that the switch should be open, Q1 is turned off. The impedance at the diodes D1 and D2 will become quite high and reflective so the radio frequency antenna coming from the radio frequency in is reflected back. In the preferred embodiment, this increases the attenuation by 25 dB, causing the worst-case radio frequency drive level to be −3 dBm, not enough to provide a useful input to the power amplifier.

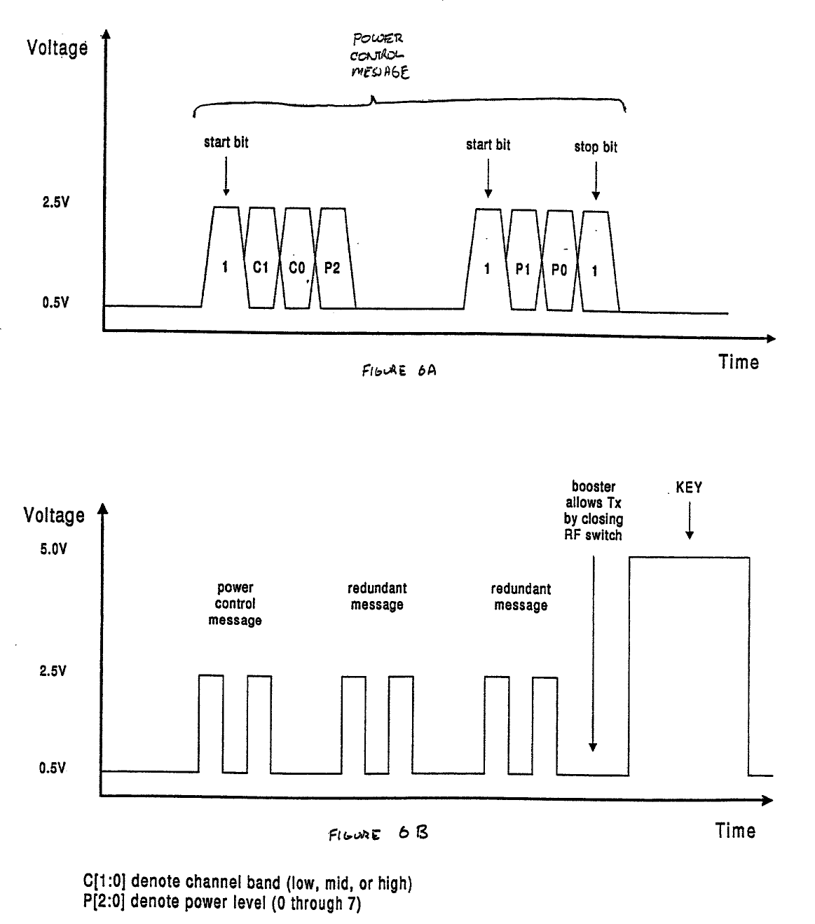

FIG. 5 is an illustration of how the auto-detect power protection circuitry and the baseband signal transmission is produced in the radio modem and booster unit. The modem includes a serial path circuit 60 and the booster includes the serial path circuits 62. This allows baseband signals to be sent across the RF connection wires 64. These baseband signals preferably include power control signals for the booster unit which are used by the booster unit to set the control levels and to determine whether to allow radio frequency signals to go to the power amplifier. The modem 64 includes an auto-detect unit 66 like that described in FIGS. 1 and 2, and booster unit 68 includes the auto-detect 70 like that described in FIG. 2. The power amplifier protection circuit 72 protects the power amplifier from RF transmitted power as described above with respect to FIGS. 3 and 4.

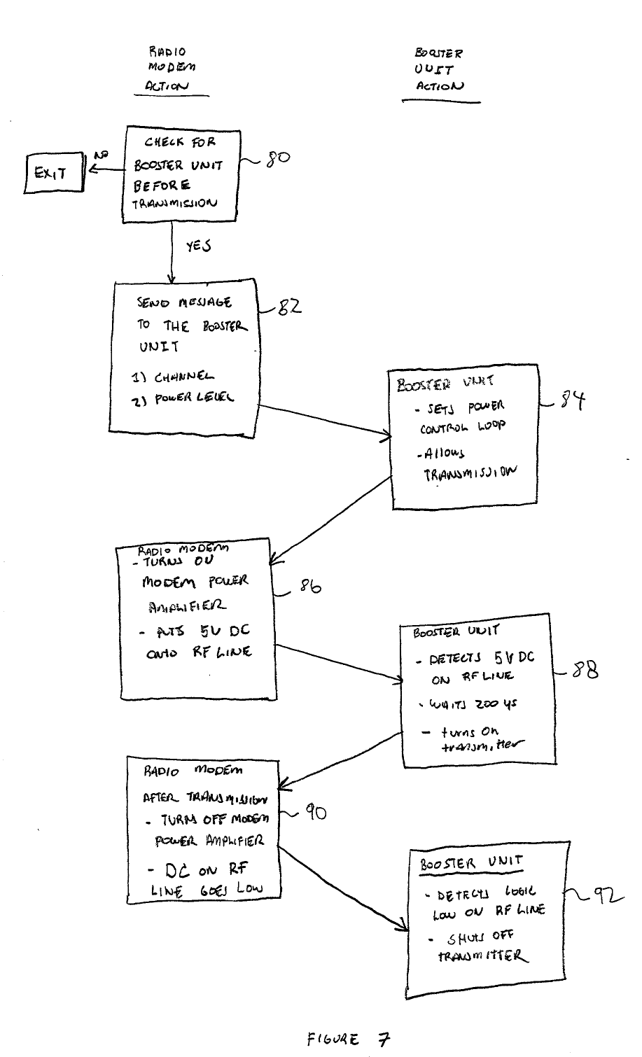

FIGS. 6A and 6B illustrate the power control system of the present invention. As shown in FIG. 6A, the power control message is a baseband signal in which C[1:0] denotes the channel band and P[2:0] denotes the power level 0-7. The power control message is transmitted from the radio modem to the booster unit. As shown in FIG. 6B, in a preferred embodiment, redundant messages are transmitted to provide error control. In one embodiment, as long as two of the three power control messages match, their matching power control message is used by the booster unit.

The power control messages are sent using the circuit path unit 60 in modem unit 64 and the serial path unit 62 in the booster unit 68 as shown in FIG. 5.

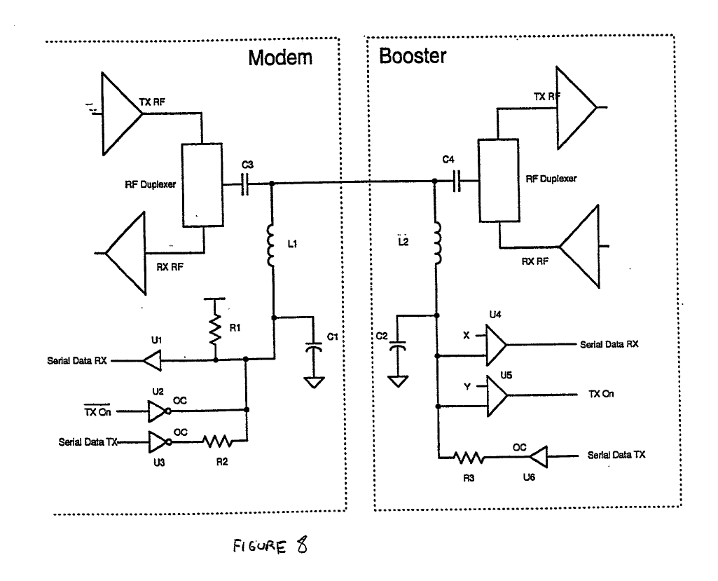

FIG. 7 is a diagram flowchart of the system of one embodiment of the present invention. In step 80, the radio modem unit checks to see whether the booster unit is connected. This can be done by the DC offset detection as shown in FIGS. 1 and 2. If a booster unit is detected in step 82, the radio modem unit produces a power control message sent to the booster unit. The power control message preferably includes channel information and power level information. In step 84, the booster unit sets the power control unit loop based upon the power control message received from the radio modem and allows transmission. In step 86, the radio modem turns on the modem power amplifier and puts 5V DC offset on the radio frequency line. In step 88, the booster unit detects the 5V DC offset on the radio frequency line, waits 200 μsec, and then turns on the transmitter. The wait of 200 μsec prevents the transmitter in the booster unit from being turned on before the power amplifier in the radio modem is completely operational. In step 90, the radio, after transmission, turns off the modem power amplifier and the five-volt DC offset on the RF line. The booster unit, in step 92, detects the logic low on the RF line and shuts off the transmitter.

FIG. 8 illustrates another preferred embodiment of the present invention. In this embodiment, multiple signals are multiplexed onto a single coaxial cable. The signals to be multiplexed include the RF signal to be transmitted or received (preferably at a frequency in the range of 824 to 896 MHz) and the logical commands between the modem and the booster (at a frequency range of DC to roughly 100 KHz). An interface circuit is included at both ends of the coax cable to combine these signals in such a way that neither one is degraded.

In FIG. 8, the inverting logic elements are open collective active pullup to the 5 volt supply. The non-inverting logic elements are open collector active pulldown to ground.

The duplexing filter, that is, the filter that feeds the RF and low-frequency signals onto the same conductor, is identical at both ends of the cable. It is made up of, at the modem end, capacitor C3, inductor L1, and capacitor C1. At the booster end, it is made up of capacitor C4, inductor L2 and capacitor C2. Capacitor C3 is preferably chosen to have a low impedance in the frequency range of 824 to 896 MHz, but a very high impedance at frequencies of 100 KHz and below. Inductor L1 is preferably chosen to have a very high impedance in the frequency range of 824 to 896 MHz, but a very low impedance at frequencies below 100 KHz. As a result, RF signals travel through capacitor C3 unimpeded, but do not pass through inductor L1 easily, whereas low-frequency logical signaling passes easily through inductor L1 but not through capacitor C3. Capacitor C1 exists to further attenuate any RF energy that does get through inductor L1. The RF duplexer serves a similar function to further attenuate any low-frequency energy that gets through capacitor C3.

The identical function is also performed at the booster end where inductor L2 does the job similar to inductor L1, C4 acts similarly to capacitor C3, and capacitor C2 functions like capacitor C1.

In this particular implementation, there are two kinds of logic signaling from the modem to the booster. In the first of the two methods, serial data is sent, via inverter U3, as binary signaling where a logical 0 is at ground potential and a logical 1 is sent at a potential of 2.5 volts. This binary signaling can carry any general-purpose logical messages. Serial signaling is received at the booster end by comparator U4. The comparison voltage, X, is set at 1.25 volts to allow the comparator to distinguish between a 1 and a 0 in the serial data stream.

Since this serial signaling takes a significant amount of time, it is not appropriate for commands that must pass without any delay at all. There is one such command, that which turns the RF transmit portion of the booster ON. This command is implemented as a third level of voltage on the wire. Inverter U2, when switched ON, will force the potential on the wire to 5V commanding the booster to turn ON its RF transmit circuits. While this command is active, the serial data receiver in the booster, comparator U4, receives an invalid voltage (neither 0 nor 2.5 volts). As a result, while the transmit command is active, serial data cannot be transferred between the two pieces of equipment; the two command methods are mutually exclusive in time.

Communications in the other direction, from booster to modem, are simpler. For all the above discussions, any buffer U6 is normally ON, allowing current to flow through resistor R3 to ground. If the modem has requested information from the booster, it will halt sending any data and wait for the booster to send its message. The booster sends its message through buffer U6. When buffer U6 turns off, the voltage seen by buffer U1 will be 5V rather than the usual 2.5V. So the booster can send binary data using two levels, 5V and 2.5V.

The protocol used to send serial information back and forth can follow one of many schemes. The simplest is to use conventional asynchronous 7 or 8 it characters in much the same fashion as an RS232 port would operate. The command definitions and the master-slave handshake between the two boxes can be any arbitrary or industry standard method as desirable,

It will be appreciated by those of ordinary skill in the art that the invention can be implemented in other specific forms without departing from the spirit or character thereof. The presently disclosed embodiments are therefore considered in all respects to be illustrative and not restrictive. The scope of the invention is illustrated by the appended claims rather than the foregoing description, and all changes that come within the meaning and range of equivalents thereof are intended to be embraced herein.

1. A system comprising:
a radio modem unit; and
an RF signal booster unit, wherein the booster unit is connectable to the RF signal booster unit with a connector adapted to transmit RF signals, wherein a DC offset at the connector is detected to determine whether the booster unit is connected to radio modem.

2. The system of claim 1, wherein the connector connects to a connection line between the radio modem unit and the booster unit.

3. The system of claim 1, wherein the offset detection circuitry is located within the radio modem unit.

4. The system of claim 1, wherein the offset detection circuitry includes an inductor to allow the DC offset to be placed onto the connector, but not allow radio frequency energy to pass up into the auto-detect circuit.

5. The system of claim 1, wherein the booster unit includes an element to reduce the DC power level to low if the radio modem unit is connected to the booster unit.

6. The system of claim 5, wherein the elements in the booster unit include an inductor.

7. The system of claim 1, wherein the voltage at the connector of the radio modem unit is high if no booster unit is connected but is low if a booster unit is connected.

8. A radio modem unit comprising:
a radio;
an RF signal connector operably connected to the radio, the connector being connectable to a RF antenna or a booster unit; and
a detector unit adapted to detect a DC offset at the connector to determine whether the connector is connected to a booster unit.

9. The radio modem unit of claim 8, wherein the connector is connectable to a connector line which can connect the radio modem unit to a booster unit.

10. The radio modem unit of claim 8, wherein the DC offset of the connector is high if no booster unit is connected but is low if a booster unit is connected.

11. The radio modem unit of claim 8, wherein an inductor is used as part of an auto-detect circuit.

12. The radio modem unit of claim 8, wherein the radio modem unit is connected to a booster unit, the booster unit including a circuit to pull the DC offset at the connector to low.

13. A system comprising:
a radio modem unit; and
an RF signal booster unit, wherein the booster unit is connectable to the RF signal booster unit with a connector adapted to transmit RF signals, wherein baseband signals transmitted to the connector by the radio modem are used by the booster unit to prepare for transmission.

14. The system of claim 13, wherein a connector line is connected between the connector at the RF signal booster unit to a connector at the radio modem unit.

15. The system of claim 13, wherein the baseband signals are power control signals.

16. The system of claim 13, wherein the power control signals are used to control the power and channel.

17. The system of claim 13, wherein the RF signal booster unit includes a switch in the transmit line that prevents RF energy from being provided to a power amplifier in the booster unit until a valid power controller message is received from the radio modem.

18. The system of claim 13, wherein DC offset signals are sent between the radio modem and booster unit to indicate whether the radio modem unit is connected to the booster unit.

19. An RF signal booster unit adapted to amplify RF signals from a radio modem, the booster unit includes a switch that significantly attenuates the RF energy from the radio modem that is provided to a power amplifier in the booster unit until a valid power control message is received from the radio modem.

20. The RF signal booster unit of claim 19, wherein the switch includes a pair of diodes.

21. The system of claim 20, wherein the current flows through the diodes, the RF impedance of the diodes is reduced, turning the switch to closed, but when current is not flowing through the diodes, the RF impedance of the switch is high.

22. Method of using a radio modem unit and an RF signal booster unit, the booster unit and radio modem unit connectable using a connector, the method comprising:
in the radio modem unit, detecting a DC offset on the connector to determine whether the booster unit is connected;
if the booster unit is connected, transmitting baseband signals on the connector from the radio modem to the booster unit to allow the booster unit to prepare for transmission; and
thereafter, transmitting an RF signal on the connector from the radio modem to the booster unit.

23. The method of claim 22, wherein the connector line connects between the radio modem unit and an RF signal booster unit.

24. The method of claim 22, wherein the baseband signal is the power control signal.

25. The method of claim 24, wherein the power control signal includes a channel control and power level indications.
